(19) United States
(12) Patent Application Publication
(10) Pub. No.: US 2024/0224159 A1
(43) Pub. Date: Jul. 4, 2024

(54) METHOD FOR PER ACCESS TYPE NETWORK SLICE ADMISSION CONTROL

(71) Applicant: ZTE Corporation, Shenzhen (CN)

(72) Inventors: Menghan Wang, Shenzhen (CN); Shuang Liang, Shenzhen, Guangdong (CN); Jinguo Zhu, Shenzhen (CN); Xingyue Zhou, Shenzhen, Guangdong (CN)

(73) Assignee: ZTE Corporation, Shenzhen (CN)

(21) Appl. No.: 18/606,698

(22) Filed: Mar. 15, 2024

Related U.S. Application Data
(63) Continuation of application No. PCT/CN2021/128765, filed on Nov. 4, 2021.

(51) Int. Cl. H04W 48/02; H04W 48/20; H04W 76/16

(52) U.S. Cl. CPC H04W 48/02; H04W 48/20; H04W 76/16

(57) ABSTRACT

A wireless communication method for use in a wireless network node is disclosed. The method comprises transmitting, to a wireless terminal, a rejection cause associated with a first connectivity request and an indication for at least one access type associated with the rejection cause.

### CROSS-REFERENCE TO RELATED APPLICATIONS

This application is a continuation of PCT/CN2021/128765, filed on Nov. 4, 2021, titled “METHOD FOR PER ACCESS TYPE NETWORK SLICE ADMISSION CONTROL”, and published as WO 2023/077370 A1, the entirety of which is incorporated herein by reference.

### TECHNICAL FIELD

This document is directed generally to wireless communications, and in particular to 5th generation (5G) wireless communications.

### BACKGROUND

In a 5G network, a Network Slice Admission Control (NSAC) may be introduced for monitoring and controlling the number of registered user equipments (UEs) per network slice and the number of protocol data unit (PDU) Sessions per network slice for the network slices that are subject to the NSAC. However, how to support the NASC for the number of PDU Sessions per network slice and/or the number of UEs per network slice when access types are taking into consideration is a topic to be discussed.

### SUMMARY

This document relates to methods, systems, and devices for per access type NASC, in particular to per access type NASC in a 5G system.

The present disclosure relates to a wireless communication method for use in a wireless network node. The method comprises:
transmitting, to a wireless terminal, a rejection cause associated with a first connectivity request and an indication for at least one access type associated with the rejection cause.

Various embodiments may preferably implement the following features:

Preferably, the first connectivity request is a protocol data unit session establishment request or a packet data network connectivity request.

Preferably, the wireless communication method further comprises:
receiving, from a network slice admission control function, a network slice admission control result associated with a rejection for the first connectivity request.

Preferably, the network slice admission control result indicates at least one of:
a maximum number of wireless terminals associated with a network slice or single network slice selection assistance information has been reached, or
a maximum number of protocol data unit sessions associated with a network slice or single network slice selection assistance information has been reached.

Preferably, the rejection cause indicates at least one of:
insufficient resources,
a maximum number of wireless terminals associated with a network slice or single network slice selection assistance information has been reached, or
a maximum number of protocol data unit sessions associated with a network slice or single network slice selection assistance information has been reached.

Preferably, the at least one access type comprises at least one of a 3rd generation partnership project, 3GPP, access type, a non-3GPP access type, or a first access type associated with the first connectivity request.

Preferably, the at least one access type comprises only a first access type associated with the first connectivity request and wherein the method further comprises:
receiving, from the wireless terminal, a second connectivity request over a second access type different from the first access type, wherein the first connectivity request and the second connectivity request are associated with the same single network slice selection assistance information or the same access point name.

Preferably, the rejection cause indicates insufficient resources and the first connectivity request and the second connectivity request are associated with the same access point name.

Preferably, the at least one access type comprises only a first access type associated with the first connectivity request and the method further comprises:
receiving, from the wireless terminal, a second connectivity request over the first access type associated with the first connectivity request after a back-off timer expires, wherein the first connectivity request and the second connectivity request are associated with the same single network slice selection assistance information or the same access point name.

Preferably, the at least one access type comprises a 3GPP access type and a non-3GPP access type and the method further comprises:
receiving, from the wireless terminal, a second connectivity request over the 3GPP access type or the non-3GPP access type after a back-off timer expires, wherein the first connectivity request and the second connectivity request are associated with the same single network slice selection assistance information or the same access point name.

Preferably, the rejection cause indicates insufficient resources and the first connectivity request and the second connectivity request are associated with the same access point name.

Preferably, the wireless communication method further comprises:
transmitting, to the wireless terminal, a back-off timer associated with the first connectivity request.

Preferably, the wireless network node comprises at least one of a session management function or a combination node of a session management function and a packet data network gateway control plane function.

The present disclosure relates to a wireless communication method for use in a wireless terminal. The method comprises:
receiving, from a wireless network node, a rejection cause associated with a first connectivity request and an indication for at least one access type associated with the rejection cause.

Various embodiments may preferably implement the following features:

Preferably, the first connectivity request is a protocol data unit session establishment request or a packet data network connectivity request.

Preferably, the rejection cause indicates at least one of:
insufficient resources,
a maximum number of wireless terminals associated with a network slice or single network slice selection assistance information has been reached, or
a maximum number of protocol data unit sessions associated with a network slice or single network slice selection assistance information has been reached.

Preferably, the at least one access type comprises at least one of a 3rd generation partnership project, 3GPP, access type, a non-3GPP access type, or a current access type associated with the first connectivity request.

Preferably, the wireless communication method further comprises:
transmitting, to the wireless network node, a second connectivity request associated with the same single network slice selection assistance information or the same access point name as the first connectivity request based on at least one of the rejection cause or the indication.

Preferably, the at least one access type comprises only a first access type associated with the first connectivity request and the method further comprises:
transmitting, to the wireless network node, a second connectivity request over a second access type different from the first access type, wherein the first connectivity request and the second connectivity request are associated with the same single network slice selection assistance information or the same access point name.

Preferably, the rejection cause indicates insufficient resources, and the first connectivity request and the second connectivity request are associated with the same access point name.

Preferably, the at least one access type comprises only a first access type associated with the first connectivity request and the method further comprises:
transmitting, to the wireless network node, a second connectivity request over the first access type associated with the first connectivity request after a back-off timer expires, wherein the first connectivity request and the second connectivity request are associated with the same single network slice selection assistance information or the same access point name.

Preferably, the at least one access type comprises a 3GPP access type and a non-3GPP access type and the method further comprises:
transmitting, to the wireless network node, a second connectivity request over the 3GPP access type or the non-3GPP access type after a back-off timer expires, wherein the first connectivity request and the second connectivity request are associated with the same single network slice selection assistance information or the same access point name.

Preferably, the rejection cause indicates insufficient resources and the first connectivity request and the second connectivity request are associated with the same access point name.

Preferably, the wireless communication method further comprises:
receiving, from a wireless network node, a back-off timer associated with the first connectivity request.

Preferably, the wireless network node comprises at least one of a session management function or a combination node of a session management function and a packet data network gateway control plane function.

The present disclosure relates to a wireless network node. The wireless network node comprises:
a communication unit, configured to transmit, to a wireless terminal, a rejection cause associated with a first connectivity request and an indication for at least one access type associated with the rejection cause.

Various embodiments may preferably implement the following feature:

Preferably, the wireless network node further comprises a processor configured to perform any of the aforementioned wireless communication methods.

The present disclosure relates to a wireless terminal. The wireless terminal comprises:
a communication unit, configured to receive, from a wireless network node, a rejection cause associated with a first connectivity request and an indication for at least one access type associated with the rejection cause.

Various embodiments may preferably implement the following feature:

Preferably, the wireless terminal further comprises a processor configured to perform any of the aforementioned wireless communication methods.

The present disclosure relates to a computer program product comprising a computer-readable program medium code stored thereupon, the code, when executed by a processor, causing the processor to implement a wireless communication method recited in any one of foregoing methods.

The exemplary embodiments disclosed herein are directed to providing features that will become readily apparent by reference to the following description when taken in conjunction with the accompany drawings. In accordance with various embodiments, exemplary systems, methods, devices and computer program products are disclosed herein. It is understood, however, that these embodiments are presented by way of example and not limitation, and it will be apparent to those of ordinary skill in the art who read the present disclosure that various modifications to the disclosed embodiments can be made while remaining within the scope of the present disclosure.

Thus, the present disclosure is not limited to the exemplary embodiments and applications described and illustrated herein. Additionally, the specific order and/or hierarchy of steps in the methods disclosed herein are merely exemplary approaches. Based upon design preferences, the specific order or hierarchy of steps of the disclosed methods or processes can be re-arranged while remaining within the scope of the present disclosure. Thus, those of ordinary skill in the art will understand that the methods and techniques disclosed herein present various steps or acts in a sample order, and the present disclosure is not limited to the specific order or hierarchy presented unless expressly stated otherwise.

The above and other aspects and their implementations are described in greater detail in the drawings, the descriptions, and the claims.

### BRIEF DESCRIPTION OF THE DRAWINGS

FIG. 1 shows a schematic diagram of a network according to an embodiment of the present disclosure.

FIG. 2 shows a schematic diagram of procedure according to an embodiment of the present disclosure.

FIG. 3 shows a schematic diagram of procedure according to an embodiment of the present disclosure.

FIG. 4 shows a schematic diagram of procedure according to an embodiment of the present disclosure.

FIG. 5 shows an example of a schematic diagram of a wireless terminal according to an embodiment of the present disclosure.

FIG. 6 shows an example of a schematic diagram of a wireless network node according to an embodiment of the present disclosure.

FIG. 7 shows a flowchart of a method according to an embodiment of the present disclosure.

FIG. 8 shows a flowchart of a method according to an embodiment of the present disclosure.

### DETAILED DESCRIPTION

In the present disclosure, a Network Slice represents a logical network that provides specific network capabilities and network characteristics.

In the present disclosure, a Network Slice instance represents a set of Network Function instances and the required resources (e.g. compute, storage and networking resources) which form a deployed Network Slice.

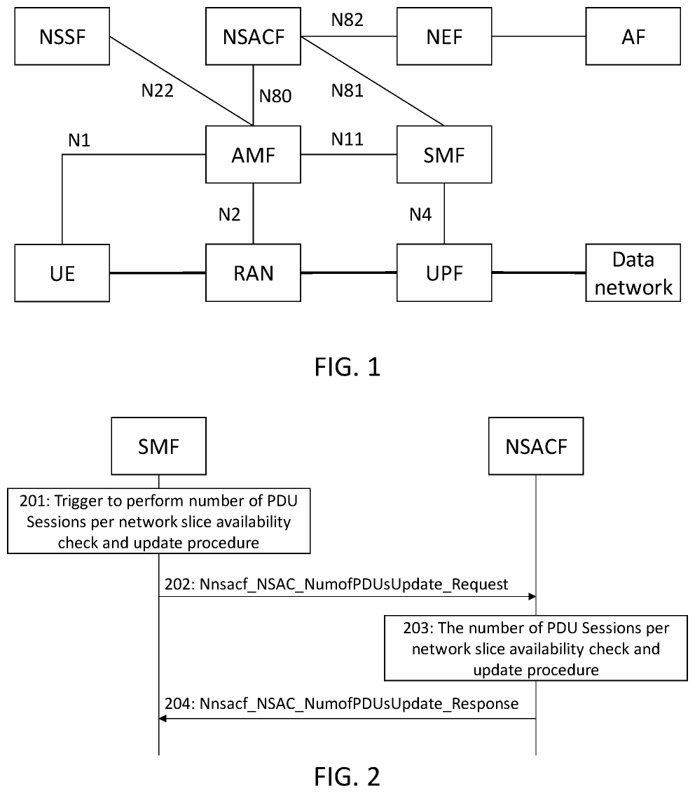

FIG. 1 shows a schematic diagram of a network system (e.g. network architecture) according to an embodiment of the present disclosure. For example, the network system shown in FIG. 1 may be a 5G system (5GS). In FIG. 1, the network system comprises the following network functions/entities:
1) UE: User Equipment
2) RAN: Radio Access Network

In the present disclosure, the RAN may be equal to RAN node, or next-generation RAN (NG-RAN) (node).
3) AMF: Access and Mobility Management Function

The AMF includes functionalities such as UE Mobility Management, Reachability Management, Connection Management and Registration Management. The AMF terminates a RAN control plane (CP) interface N2 and a non-access stratum (NAS) interface N1, a NAS ciphering and integrity protection. The AMF also distributes a session management (SM) NAS to proper SMFs via N11 interface(s).

The AMF is configured with information indicating network slice(s) subject to the NSAC. The AMF triggers the number of UEs per network slice availability check and update procedure to a Network Slice Admission Control Function (NSACF) to update the number of UEs registered with a network slice subject to the NSAC when this network slice is included in Allowed Network Slice Selection Assistance information (NSSAI) (i.e. the AMF requests to register the UE with the single NSSAI (S-NSSAI)) or removed from the Allowed NSSAI (i.e. the AMF requests to de-register the UE from the S-NSSAI) for the UE.
4) SMF: Session Management Function

The SMF includes the following functionalities: session establishment, modification and release, UE IP address allocation & management, selection and control of user plane (UP) function, etc.

The SMF is configured with the information indicating the network slice(s) subject to the NSAC. The SMF anchoring the PDU session triggers the number of PDU Sessions per network slice availability check and update procedure to the NSACF for the network slices that are subject to the NSAC at the beginning of a PDU Session Establishment procedure (only for new PDU Sessions) or as a last step of successful PDU Session Release procedure.
5) NSACF: Network Slice Admission Control Function

The NSACF supports monitoring and controlling the number of registered UEs per network slice and the number of established PDU sessions per network slice. The NSACF also supports event based network slice status notification and reports to a consumer NF (e.g. a network exposure function (NEF) or an application function (AF)).
6) NSSF: Network Slice Selection Function

The NSSF supports the following functionality: selecting a set of Network Slice instances serving the UE; determining the Allowed NSSAI and, if needed, the mapping to home public land mobile network (HPLMN) S-NSSAIs; determining Configured NSSAI and, if needed, the mapping to the HPLMN S-NSSAIs; determining an AMF Set to be used to serve the UE or, based on configuration, a list of candidate AMF(s), possibly by querying a Network Repository Function (NRF).
7) UPF: User Plane Function

The UPF serves as an anchor point for intra-/inter-radio access technology (RAT) mobility and as an external PDU session point of interconnect to Data Network (DN). The UPF also routes and forwards the data packet according to the indication from the SMF. The UPF also buffers downlink (DL) data when the UE is in idle mode.
8) NEF: Network Exposure Function

The NEF supports exposure of capabilities and events. The AF can access the NSACF services via the NEF if the AF is untrusted.
9) AF: Application Function

The AF can access NSACF services via the NEF if the AF is untrusted or the AF can access NSACF services directly if the AF is trusted.

FIG. 2 shows a schematic diagram of the number of PDU Sessions per network slice availability check and update procedure according to an embodiment of the present disclosure. The number of PDU Sessions per network slice availability check and update procedure is used to update (e.g. increase or decrease) the number of PDU Sessions established on an S-NSSAI (i.e. network slice) which is subject to the NSAC. The SMF is configured with the information indicating the network slice(s) subject to the NSAC.

In step 201, if the SMF is not aware of which NSACF to communicate, the SMF performs an NSACF discovery. The SMF anchoring the PDU session triggers the number of PDU Sessions per network slice availability check and update procedure to the NSACF for network slices that are subject to the NSAC at the beginning of a PDU Session Establishment procedure (only for new PDU Sessions to be established) and/or as a last step of a successful PDU Session Release procedure.

In step 202, the SMF anchoring the PDU session sends a Nnsacf_NSAC_NumOfPDUsUpdate_Request message to the NSACF. The SMF includes in the message a UE identifier (ID), a PDU session ID, an S-NSSAI for which the number of PDU Sessions per network slice update is required, an access type and a update flag which indicates that the number of PDU sessions established on the S-NSSAI is to be increased if the procedure is triggered at the beginning of PDU Session Establishment procedure or indicates that the number of PDU Sessions on the S-NSSAI is to be decreased if the procedure is triggered at the end of the PDU Sessions Release procedure.

In step 203, the NSACF updates the current number of PDU Sessions established on the S-NSSAI, i.e. increases or decreases the number of PDU Sessions per network slice based on the information provided by the anchor SMF in the update flag parameter.

If the update flag parameter from the SMF anchoring the PDU session indicates an increase and the maximum number of PDU Sessions established on the S-NSSAI has already been reached, the NSACF returns a result parameter indicating that the maximum number of PDU Sessions per network slice has been reached. If the maximum number of PDU Sessions established on the S-NSSAI has not been reached, the NSACF checks the UE ID. If the UE ID is located, the NSACF stores the PDU Session ID and increases the number of PDU Sessions for that S-NSSAI. If the NSACF cannot locate the UE ID, the NSACF creates an entry for the UE ID, stores the PDU Session ID and increases the number of PDU Sessions for that S-NSSAI.

If the update flag parameter from the SMF anchoring the PDU session indicates decreasing the current number of PDU Sessions per S-NSSAI, the NSACF locates the UE ID, decreases the number of PDU Sessions for that S-NSSAI and removes related PDU Session ID. If the UE ID has no more PDU sessions, after the decrease, the NSACF removes the UE ID entry.

In an embodiment, the NSACF takes the access type into account to determine whether to increase or decrease the number of PDU Sessions per S-NSSAI.

In step 204, the NSACF acknowledges the update to the anchor SMF via a Nnsacf_NSAC_NumOfPDUsUpdate_Response message. If the NSACF returns a maximum number of PDU Sessions per S-NSSAI reached result (i.e. a result indicating that the maximum number of PDU Sessions registered on the S-NSSAI has been reached), the SMF rejects the PDU Session establishment request with a reject cause “insufficient resources for specific slice” and optionally with a back-off timer. Under such conditions, the UE will not initiate another PDU session establishment procedure for the same S-NSSAI until the back-off timer expires.

During the number of PDU Sessions per network slice availability check and update procedure, the NSACF may takes the access type into account for whether to increase or decrease the number of PDU Sessions per S-NSSAI. However, how the NSACF determines to increase or decrease the number of PDU sessions if considering the access type remains unknown. The present disclosure provides embodiments of supporting and realizing per access type NSAC for the number of PDU sessions per S-NSSAI, e.g., in the number of PDU Sessions per network slice availability check and update procedure.

In some embodiments, based on policies of the network operator, the NSACF may be configured to apply the NSAC for the S-NSSAI only for a 3rd generation partnership project (3GPP) access type or a non-3GPP access type. Note that the number of established PDU sessions over the access type rather than the currently applied access type is not counted. Under such a condition, if the PDU session establishment request is rejected over one access type, the UE may not initiate another PDU session establishment request with the same S-NSSAI over another access type. However, when the PDU session establishment request is rejected over one access type, the UE should be allowed to initiate a PDU session establishment request with the same S-NSSAI over another access type in the 5GS. Therefore, how to support the NSAC for the number of PDU Sessions per network slice when the access type is taking into consideration (e.g. per access type NSAC) in the 5GS needs to be discussed. Similarly, how to support per access type NSAC for the number of UEs and/or the number of PDU Sessions per network slice in an evolved Packet System (EPS) (e.g. 4th generation (4G) network) is also required to be discussed.

In the present disclosure, methods for supporting per access type NSAC per S-NSSAI in the 5GS and/or the EPS (e.g. interworking network (architecture) supporting both the 5GS and the EPS) are provided.

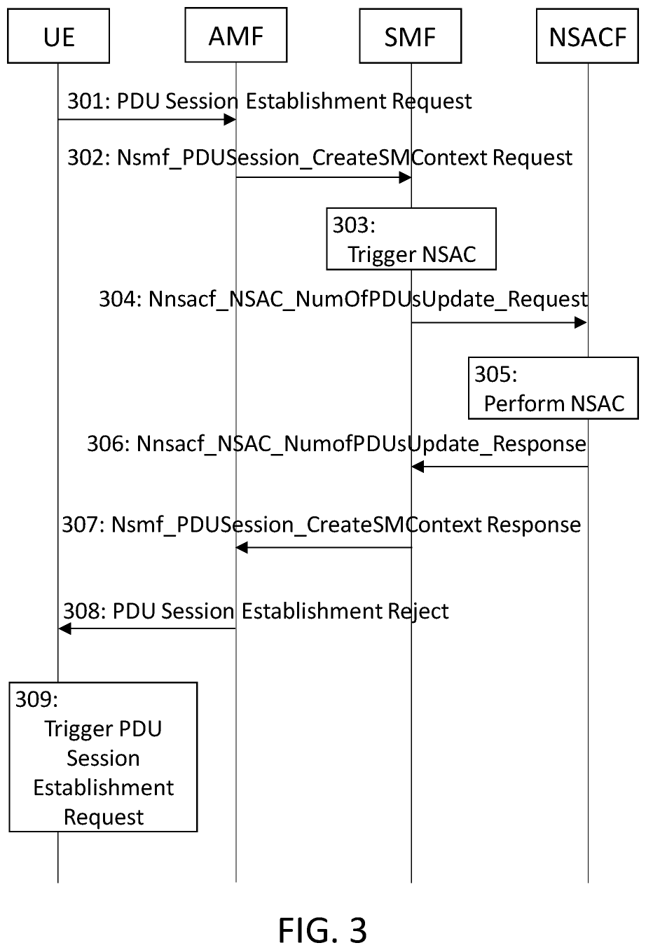

FIG. 3 shows a schematic diagram of a procedure according to an embodiment of the present disclosure. The procedure shown in FIG. 3 is associated with the per access type NSAC for the number of PDU sessions per S-NSSAI (in the 5GS) and comprises the following steps:

Step 301 (From UE to AMF): The UE initiates a UE Requested PDU Session Establishment procedure by transmitting a PDU Session Establishing Request. The PDU Session Establishment Request includes a PDU session ID, a Requested (PDU Session) Type, S-NSSAI, . . . etc.

In an embodiment, the Request Type indicates “Initial request” if the PDU Session Establishment Request is a request to establish a new PDU Session and indicates “Existing PDU Session” if the PDU Session Establishment Request associates with an existing PDU Session switching between the 3GPP access and the non-3GPP access or with a PDU Session handover from an existing PDN connection in the EPS.

The UE includes the S-NSSAI from the Allowed NSSAI of the current access type in the PDU Session Establishment Request. If the Mapping of the Allowed NSSAI was provided to the UE, the UE provides both the S-NSSAI of a visited public land mobile network (VPLMN) from the Allowed NSSAI and the corresponding S-NSSAI of the HPLMN from the Mapping of the Allowed NSSAI.

Step 302 (From AMF to SMF): If the AMF does not have an association with an SMF for the PDU Session ID provided by the UE (e.g. when the Request Type indicates “initial request”), the AMF invokes an Nsmf_PDUSession_CreateSMContext Request.

In an embodiment, the AMF sends the S-NSSAI of the Serving PLMN from the Allowed NSSAI to the SMF. In a roaming scenario in local breakout (LBO), the AMF may also send the corresponding S-NSSAI of the HPLMN from the Mapping of Allowed NSSAI to the SMF.

The AMF determines Access Type and RAT Type of the PDU session.

Step 303 (SMF): The SMF anchoring the PDU session triggers the number of PDU Sessions per network slice availability check and update procedure to the NSACF for the S-NSSAI(s) subject to the NSAC at the beginning of the PDU Session Establishment procedure (only for new PDU Sessions to be established). If the SMF is not aware of which NSACF to communicate, the SMF performs an NSACF discovery.

Step 304 (From SMF to NSACF): The SMF sends a Nnsacf_NSAC_NumOfPDUsUpdate_Request message to the NSACF. The SMF includes in the message the UE ID, the PDU session ID, the S-NSSAI for which the number of PDU Sessions per network slice update is required, the access type and the update flag. In an embodiment, the update flag indicates that the number of PDUs established on the S-NSSAI is to be increased because the procedure is triggered at the beginning of PDU Session Establishment procedure.

Step 305 (NSACF): The NSACF is configured with the information indicating which access type is specified for the S-NSSAI subject to the NSAC (i.e. the 3GPP Access Type, the Non-3GPP Access Type, or both the 3GPP Access Type and the Non-3GPP Access Type).

In an embodiment, if per access type NSAC for the S-NSSAI is required (e.g. it is configured that the NSAC is applicable to the S-NSSAI only over the 3GPP access, which means the number of PDU sessions established on the S-NSSAI over the non-3GPP access is not controlled, or it is configured that the number of PDU sessions established on the S-NSSAI over the 3GPP access and the non-3GPP access are counted separately with separate quotas) and the maximum number of PDU Sessions established on the S-NSSAI over the current access type has already been reached, the NSACF returns a result parameter indicating that the maximum number of PDU Sessions on the S-NSSAI over the current access type has been reached. In this embodiment, the result parameter applies only to the current access type, e.g., included in the Nnsacf_NSAC_NumOfPDUsUpdate_Request message.

If per access type NSAC for the S-NSSAI is not required and the maximum number of PDU Sessions established on the S-NSSAI has already been reached, the NSACF returns a result parameter indicating that the maximum number of PDU Sessions on the S-NSSAI has been reached. In this embodiment, the result parameter applies to both the 3GPP access type and the non-3GPP access type.

Step 306 (From NSACF to SMF): The NSACF acknowledges the update to the SMF via a Nnsacf_NSAC_NumOfPDUsUpdate_Response message.

Step 307 (From SMF to AMF): In an embodiment, if the NSACF returns that the maximum number of PDU Sessions established on the S-NSSAI over the current access type has already been reached, the SMF rejects the PDU Session establishment request with an rejection cause that the maximum number of PDU sessions on a specific network slice has already been reached. In this embodiment, the result parameter applies only to the current access type. The SMF further transmits an indication that the rejection cause only applies to current access type in this embodiment. In addition, the SMF may optionally transmit a back-off timer associated with the rejection cause.

In an embodiment, if the NSACF returns that the maximum number of PDU Sessions established on the S-NSSAI has already been reached, the SMF rejects the PDU Session establishment request with a rejection cause that the maximum number of PDU sessions on a specific slice has already been reached. In this embodiment, the result parameter applies only to both the 3GPP access type and the non-3GPP access type. The SMF transmits an indication of the rejection cause applied to both the 3GPP access type and the non-3GPP access type. In addition, the SMF may optionally transmit a back-off timer associated with the rejection cause.

In an embodiment, the SMF rejects the UE request via a NAS SM signaling by responding to the AMF with an Nsmf_PDUSession_CreateSMContext Response. The SMF also indicates the AMF that the PDU Session ID is to be considered as released and the PDU Session Establishment procedure is stopped.

Step 308 (From AMF to UE): The AMF forwards the NAS SM message to the UE.

Step 309 (UE): In an embodiment, if the UE receives the rejection cause that the maximum number of PDU sessions on a specific slice has already been reached and the indication that the rejection cause applies only to the current access type, the UE may immediately initiate another PDU session establishment procedure to establish the PDU session with the same S-NSSAI over the other access type (i.e. the access type different from the current access type included in the PDU Session Establishing Request). As an alternative, the UE may initiate another PDU session establishment procedure to establish the PDU session with the same S-NSSAI over the current access type after an associated back-off timer expires. The UE may receive the associated back-off timer from along with the rejection cause.

In an embodiment, if the UE receives the rejection cause that the maximum number of PDU sessions on a specific slice has already been reached and the indication that the rejection cause applies to both the 3GPP access type and the non-3GPP access type, the UE may initiate another PDU session establishment procedure to establish the PDU session with the same S-NSSAI over the current access type or the other access type after an associated back-off timer expires. The UE may receive the associated back-off timer along with the rejection cause.

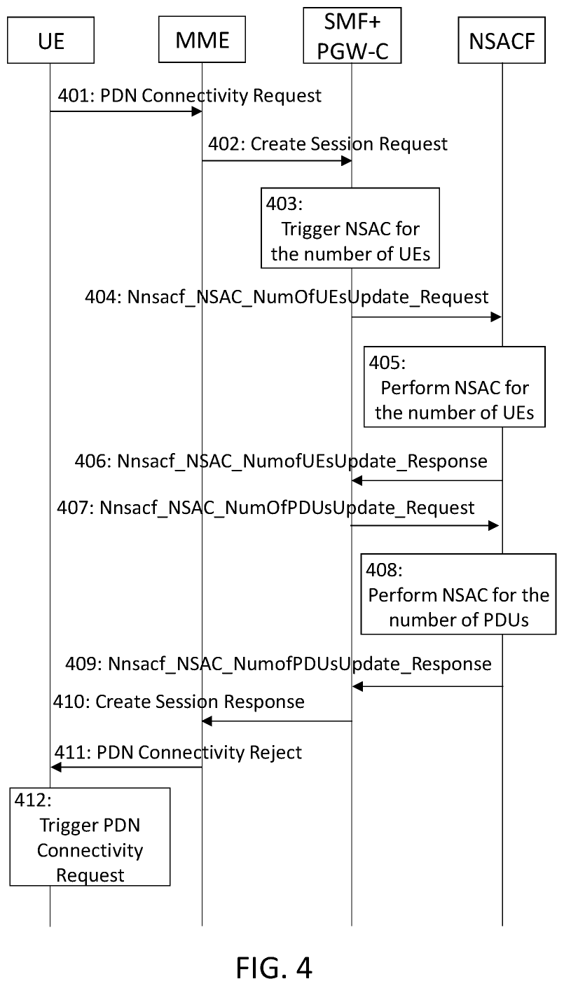

FIG. 4 shows a schematic diagram of a procedure according to an embodiment of the present disclosure. The procedure shown in FIG. 4 is associated with Per access type NSAC in an Evolved Packet System (EPS) or an interworking network (architecture) supporting both the 5GS and the EPS and comprises the following steps:

Step 401 (From UE to Mobility Management Entity (MME)): The UE initiates a UE Requested packet data network (PDN) procedure by transmitting a PDN Connectivity Request message. The PDN Connectivity Request includes an access point name (APN), a PDN Type, Protocol Configuration Options (PCO), a Request Type, a PDU session ID and etc.

Step 402 (From MME to SMF+PGW-C): The MME sends a Create Session Request to the SMF+PGW-C.

Step 403 (SMF+PGW-C): The SMF+PGW-C is configured with the information indicating which S-NSSAI is subject to the NSAC. In an embodiment, the SMF+PGW-C is configured with the information indicating which S-NSSAI is subject to the NSAC only in the 5GS.

In an embodiment, the SMF+PGW-C selects an S-NSSAI associated with the PDN connection. If the selected S-NSSAI by the SMF+PGW-C is subject to the NSAC in both the EPS and the 5GS, the SMF+PGW-C triggers an interaction with the NSACF to check an availability of the S-NSSAI by invoking separate NSAC procedures for the number of UEs and the number of PDU Sessions in sequence.

Step 404 (From SMF+PGW-C to NSACF): The SMF+PGW-C sends an Nnsacf_NSAC_NumOfUEsUpdate_Request message to the NSACF. The SMF+PGW-C includes in the message the UE ID, the access type, the S-NSSAI(s), the NF ID and the update flag which indicates the number of UEs registered with the S-NSSAI(s) is to be increased.

Step 405 (NSACF): The NSACF is configured with the information indicating which access type is specified for the S-NSSAI subject to the NSAC (i.e. the 3GPP Access Type, the Non-3GPP Access Type, or both the 3GPP Access Type and the Non-3GPP Access Type).

In an embodiment, if per access type NSAC for the S-NSSAI is required and the maximum number of UEs registered on the S-NSSAI over the current access type has already been reached, the NSACF returns a result parameter indicating that the maximum number of UEs registered on the S-NSSAI over the current access type has been reached. In this embodiment, the result parameter applies only to the current access type.

In an embodiment, if per access type NSAC for the S-NSSAI is not required and the maximum number of UEs registered on the S-NSSAI has already been reached, the NSACF returns a result parameter indicating that the maximum number of UEs registered on the S-NSSAI has been reached. In this embodiment, the result parameter applies to both the 3GPP access type and the non-3GPP access type.

In an embodiment, if the maximum number of UEs registered on the S-NSSAI has not been reached, the NSACF records the registration and returns a success result.

Step 406 (From NSACF to SMF+PGW-C): The NSACF acknowledges the update to the SMF+PGW-C with an Nnsacf_NSAC_NumOfUEsUpdate_Response message.

Note that if the maximum number of UEs registered on the S-NSSAI has already been reached, the following steps 407 to 409 may be skipped. In an embodiment, if the NSACF returns a success result (i.e. the maximum number of UEs registered on the S-NSSAI has not been reached), the following steps 407 to 409 are performed.

Step 407 (From SMF+PGW-C to NSACF): The SMF+PGW-C sends an Nnsacf_NSAC_NumOfPDUsUpdate_Request message to the NSACF. The SMF+PGW-C includes in the message the UE ID, the PDU session ID, the S-NSSAI for which the number of PDU Sessions per network slice update is required, the access type and the update flag which indicates that the number of PDUs established on the S-NSSAI is to be increased.

Step 408 (NSACF): The NSACF is configured with the information indicating which access type is specified for the S-NSSAI subject to the NSAC (i.e. the 3GPP Access Type, the Non-3GPP Access Type, or both the 3GPP Access Type and the Non-3GPP Access Type).

In an embodiment, if per access type NSAC for the S-NSSAI is required and the maximum number of PDU Sessions established on the S-NSSAI over the current access type has already been reached, the NSACF returns a result parameter indicating that the maximum number of PDU Sessions on the S-NSSAI over the current access type has been reached. Note that the result parameter only applies to the current access type.

In an embodiment, if per access type NSAC for the S-NSSAI is not required and the maximum number of PDU Sessions established on the S-NSSAI has already been reached, the NSACF returns a result parameter indicating that the maximum number of PDU Sessions on the S-NSSAI has been reached. In this embodiment, the result parameter applies to both the 3GPP access type and the non-3GPP access type.

Step 409 (From NSACF to SMF+PGW-C): The NSACF acknowledges the update to the SMF+PGW-C with an Nnsacf_NSAC_NumOfPDUsUpdate_Response message.

In an embodiment, the steps 407 to 409 may swap with steps 404 to 406. That is the steps 407 to 409 may be performed before steps 404 to 406. In this embodiment, the steps 404 to 406 may be omitted if the maximum number of PDU sessions established on the S-NSSAI has been reached. In an embodiment, if the NSACF returns a success result (i.e. the maximum number of the PDU sessions established on the S-NSSAI has not been reached), the steps 404 to 406 are performed.

Step 410 (From SMF+PGW-C to MME):

In an embodiment, if the NSACF returned that the maximum number of UEs or the maximum number of PDU Sessions on the S-NSSAI over the current access type has already been reached, the SMF+PGW-C rejects the PDN connection establishment request with a rejection cause “insufficient resources” or a rejection cause that the maximum number of UEs or the maximum number of PDU sessions on a specific network slice has already been reached. In this embodiment, the SMF+PGW-C further transmits an indication that the rejection cause applies only to the current access type.

In an embodiment, if the NSACF returned that maximum number of UEs or maximum number of PDU Sessions on the S-NSSAI has already been reached, the SMF+PGW-C rejects the PDN connection establishment request with a rejection cause “insufficient resources” or a rejection cause that the maximum number of UEs or the maximum number of PDU sessions on a specific network slice has already been reached”. In this embodiment, the SMF+PGW-C also transmits an indication that the rejection cause applies to both the 3GPP access type and the non-3GPP access type.

In an embodiment, in order to avoid impacts to the MME, the indication of the rejection cause applying to both the 3GPP access type and the non-3GPP access type or the indication of the rejection cause applying only to the current access type is transferred to the UE in a PCO information element (IE) included in the PDN connection establishment reject message.

Step 411 (From MME to UE): The MME rejects the PDN connectivity request and transmits the rejection cause and associated indication to the UE.

Step 412 (UE): In an embodiment, if the UE receives the rejection cause “insufficient resources” and the indication that the rejection cause applies only to the current access type, the UE may immediately initiate another PDN connection establishment procedure to establish the PDN connection with the same APN over the other access type. As an alternative, the UE may initiate a PDN connection establishment procedure to establish the PDN connection with the same APN over the current access type after an associated back-off timer expires. The UE may receive the associated back-off timer along with the rejection cause and the indication.

In an embodiment, if the UE receives the rejection cause that the maximum number of UEs or the maximum number of PDU sessions on a specific network slice has already been reached and the indication that the rejection cause applies only to the current access type, the UE may immediately initiate another PDN connection establishment procedure to establish the PDN connection with the same APN over the other access type. As an alternative, the UE may immediately initiate a PDU Session establishment procedure to establish the PDU Session with the same S-NSSAI over the other access type. As another alternative, the UE may initiate another PDN connection establishment procedure to establish the PDN connection with the same APN over the current access type after an associated back-off timer expires. As still another alternative, the UE may initiate another PDU Session establishment procedure to establish the PDU Session with the same S-NSSAI over the current access type after an associated back-off timer expires. The UE may receive the associated back-off timer along with the rejection cause and the indication.

In an embodiment, if the UE receives the rejection cause “insufficient resources” and the indication that the rejection cause applies to both the 3GPP access type and the non-3GPP access type, the UE may initiate another PDN connection establishment procedure to establish the PDN connection with the same APN over the current access type or the other access type after an associated back-off timer expires. The UE may receive the associated back-off timer along with the rejection cause and the indication.

In an embodiment, if the UE receives the new rejection cause that the maximum number of UEs or the maximum number of PDU sessions on a specific network slice has already been reached and the indication that the rejection cause applies to the both 3GPP access type and the non-3GPP access type, the UE may initiate another PDN connection establishment procedure to establish the PDN connection with the same APN over the current access type or the other access type after an associated back-off timer expires. As an alternative, the UE may initiate a PDU Session establishment procedure to establish the PDU Session with the same S-NSSAI over the current access type or the other access type after an associated back-off timer expires. The UE may receive the associated back-off timer along with the rejection cause and the indication.

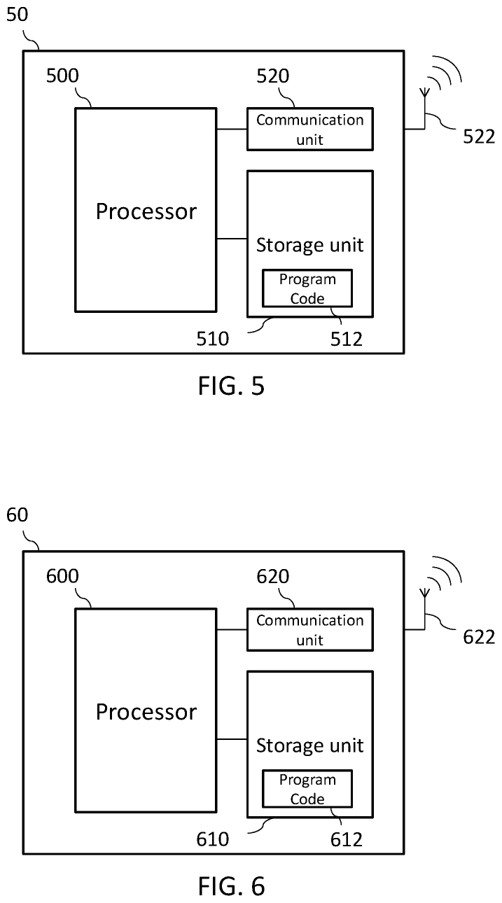

FIG. 5 relates to a schematic diagram of a wireless terminal 50 according to an embodiment of the present disclosure. The wireless terminal 50 may be a user equipment (UE), a mobile phone, a laptop, a tablet computer, an electronic book or a portable computer system and is not limited herein. The wireless terminal 50 may include a processor 500 such as a microprocessor or Application Specific Integrated Circuit (ASIC), a storage unit 510 and a communication unit 520. The storage unit 510 may be any data storage device that stores a program code 512, which is accessed and executed by the processor 500. Embodiments of the storage unit 512 include but are not limited to a subscriber identity module (SIM), read-only memory (ROM), flash memory, random-access memory (RAM), hard-disk, and optical data storage device. The communication unit 520 may a transceiver and is used to transmit and receive signals (e.g. messages or packets) according to processing results of the processor 500. In an embodiment, the communication unit 520 transmits and receives the signals via at least one antenna 522 shown in FIG. 5.

In an embodiment, the storage unit 510 and the program code 512 may be omitted and the processor 500 may include a storage unit with stored program code.

The processor 500 may implement any one of the steps in exemplified embodiments on the wireless terminal 50, e.g., by executing the program code 512.

The communication unit 520 may be a transceiver. The communication unit 520 may as an alternative or in addition be combining a transmitting unit and a receiving unit configured to transmit and to receive, respectively, signals to and from a wireless network node (e.g. a base station).

FIG. 6 relates to a schematic diagram of a wireless network node 60 according to an embodiment of the present disclosure. The wireless network node 60 may be a satellite, a base station (BS), a network entity, a Mobility Management Entity (MME), Serving Gateway (S-GW), Packet Data Network (PDN) Gateway (P-GW), a radio access network (RAN) node, a next generation RAN (NG-RAN) node, a gNB, an eNB, a gNB central unit (gNB-CU), a gNB distributed unit (gNB-DU) a data network, a core network or a Radio Network Controller (RNC), and is not limited herein. In addition, the wireless network node 60 may comprise (perform) at least one network function such as an access and mobility management function (AMF), a session management function (SMF), a user place function (UPF), a policy control function (PCF), an application function (AF), etc. The wireless network node 60 may include a processor 600 such as a microprocessor or ASIC, a storage unit 610 and a communication unit 620. The storage unit 610 may be any data storage device that stores a program code 612, which is accessed and executed by the processor 600. Examples of the storage unit 612 include but are not limited to a SIM, ROM, flash memory, RAM, hard-disk, and optical data storage device. The communication unit 620 may be a transceiver and is used to transmit and receive signals (e.g. messages or packets) according to processing results of the processor 600. In an example, the communication unit 620 transmits and receives the signals via at least one antenna 622 shown in FIG. 6.

In an embodiment, the storage unit 610 and the program code 612 may be omitted. The processor 600 may include a storage unit with stored program code.

The processor 600 may implement any steps described in exemplified embodiments on the wireless network node 60, e.g., via executing the program code 612.

The communication unit 620 may be a transceiver. The communication unit 620 may as an alternative or in addition be combining a transmitting unit and a receiving unit configured to transmit and to receive, respectively, signals to and from a wireless terminal (e.g. a user equipment or another wireless network node).

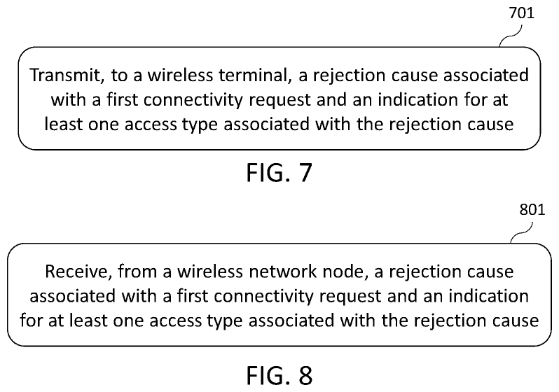

FIG. 7 shows a schematic diagram of a method according to an embodiment of the present disclosure. The method shown in FIG. 7 may be used in a wireless network node (e.g. SMF, SMF+PGW-C, a wireless network node comprising the SMF or the SMF+PGW-C, or a wireless network node performing all or at least part of functionalities of the SMF or the SMF+PGW-C) and comprises the following step:

Step 701: Transmit, to a wireless terminal (e.g. UE), a rejection cause associated with a first connectivity request and an indication for at least one access type associated with the rejection cause.

In FIG. 7, the wireless network node transmits a rejection cause associated with a first connectivity request to the wireless terminal. In this embodiment, the wireless network node transmits an indication associated with the rejection cause to the wireless terminal, wherein the indication is for (indicating) at least one access type associated with the rejection cause.

In an embodiment, the first connectivity request is a PDU establishment request or a PDN connectivity request.

In an embodiment, the wireless network node receives, from an NSACF, an NSAC result associated with a rejection for the first connectivity request. For example, the wireless network node transmits the rejection cause and the indication in response to or based on the received NSAC result.

In an embodiment, the NSAC result indicates at least one of:
a maximum number of wireless terminals associated with a network slice or S-NSSAI has been reached, or
a maximum number of protocol data unit sessions associated with a network slice or S-NSSAI has been reached.

In an embodiment, the rejection cause indicates at least one of:
insufficient resources,
a maximum number of wireless terminals associated with a network slice or S-NSSAI has been reached, or
a maximum number of protocol data unit sessions associated with a network slice or S-NSSAI has been reached.

In an embodiment, the at least one access type (indicated by or associated with the indication) comprises at least one of a 3GPP access type, a non-3GPP access type, or a first access type associated with the first connectivity request (e.g. the abovementioned current access type). For instance, the indication may comprise/indicate the first access type (e.g. one of the 3GPP access type and the non-3GPP access type). As an alternative, the indication may comprise/indicate both the 3GPP access type and the non-3GPP access type.

In an embodiment, the at least one access type comprises only a first access type associated with the first connectivity request. In this embodiment, the wireless network node receives, from the wireless terminal, a second connectivity request over a second access type different from the first access type. Note that the first connectivity request and the second connectivity request are associated with the same S-NSSAI or the same APN. That is, the second connectivity request may be a PDU establishment request or a PDN connectivity request. For example, the rejection cause indicates insufficient resources, and the first connectivity request and the second connectivity request are associated with the same APN (i.e. both the first connectivity request and the second connectivity request are the PDN connectivity request).

In an embodiment, the at least one access type comprises only a first access type associated with the first connectivity request. In this embodiment, the wireless network node receives, from the wireless terminal, a second connectivity request over the first access type associated with the first connectivity request after a back-off timer expires, wherein the first connectivity request and the second connectivity request are associated with the same single network slice selection assistance information or the same access point name. Note that the first connectivity request and the second connectivity request are associated with the same S-NSSAI or the same APN. That is, the second connectivity request may be a PDU establishment request or a PDN connectivity request.

In an embodiment, the at least one access type comprises a 3GPP access type and a non-3GPP access type. In this embodiment, the wireless network node receives, from the wireless terminal, a second connectivity request over the 3GPP access type or the non-3GPP access type after a back-off timer expires, wherein the first connectivity request and the second connectivity request are associated with the same S-NSSAI or the same APN. That is, the wireless terminal may request establishing the same PDU session or the same PDN connection after the back-off timer expires. In this embodiment, the rejection cause may indicate insufficient resources, and the first connectivity request and the second connectivity request are associated with the same access point name.

In an embodiment, the wireless network node may transmit, to the wireless terminal, a back-off timer associated with the first connectivity request.

In an embodiment, the wireless network node is/comprises at least one of an SMF or a combination node of an SMF and a PGW-C (i.e. SMF+PGW-C).

FIG. 8 shows a flowchart of a method according to an embodiment of the present disclosure. The method shown in FIG. 8 may be used in a wireless terminal (e.g. UE) and comprises the following step:

Step 801: Receive, from a wireless network node, a rejection cause associated with a first connectivity request and an indication for at least one access type associated with the rejection cause.

In FIG. 8, the wireless terminal receives a rejection cause associated with a first connectivity request from a wireless network node (e.g. SMF or SMF+PGW-C). In this embodiment, the rejection cause is received with an indication for at least one access type associated with the rejection cause. Based on the rejection cause and/or the indication, the wireless terminal determines when to transmit a second connection request to the wireless network node, wherein the first connectivity request and the second connectivity request have the same S-NSSAI or the same APN.

In an embodiment, the first connectivity request is a PDU session establishment request or a PDN connectivity request.

In an embodiment, the rejection cause indicates at least one of:
insufficient resources,
a maximum number of wireless terminals associated with a network slice or S-NSSAI has been reached, or
a maximum number of protocol data unit sessions associated with a network slice or S-NSSAI has been reached.

In an embodiment, the at least one access type (indicated by or associated with the indication) comprises at least one of a 3GPP access type, a non-3GPP access type, or a first access type associated with the first connectivity request (e.g. the abovementioned current access type). For instance, the indication may comprise/indicate the first access type (e.g. one of the 3GPP access type and the non-3GPP access type). As an alternative, the indication may comprise/indicate both the 3GPP access type and the non-3GPP access type.

In an embodiment, the at least one access type comprises only a first access type associated with the first connectivity request. In this embodiment, the wireless terminal transmits, to the wireless network node, a second connectivity request over a second access type different from the first access type, wherein the first connectivity request and the second connectivity request are associated with the same S-NSSAI (i.e. the same network slice) or the same APN. That is the wireless terminal may transmit the second connectivity request, e.g., immediately after/subsequent to receiving the rejection cause and/or the indication without waiting for a certain period of time (e.g. after a back-off timer expires). In this embodiment, the rejection cause may indicate insufficient resources, and the first connectivity request and the second connectivity request are associated with the same APN.

In an embodiment, the at least one access type comprises only a first access type associated with the first connectivity request. In this embodiment, the wireless terminal transmits, to the wireless network node, a second connectivity request over a the first access type associated with the first connectivity request after a back-off timer expires, wherein the first connectivity request and the second connectivity request are associated with the same S-NSSAI or the same APN.

In an embodiment, the at least one access type comprises a 3GPP access type and a non-3GPP access type. In this embodiment, the wireless terminal transmits, to the wireless network node, a second connectivity request over the 3GPP access type or the non-3GPP access type after a back-off timer expires, wherein the first connectivity request and the second connectivity request are associated with the same S-NSSAI or the same APN. In this embodiment, the rejection cause may indicate insufficient resources, and the first connectivity request and the second connectivity request may be associated with the same APN.

In an embodiment, the wireless network node may receive a back-off timer associated with the first connectivity request from the wireless network node.

In an embodiment, the wireless network node is/comprises at least one of an SMF or a combination node of an SMF and a PGW-C (i.e. SMF+PGW-C).

While various embodiments of the present disclosure have been described above, it should be understood that they have been presented by way of example only, and not by way of limitation. Likewise, the various diagrams may depict an example architectural or configuration, which are provided to enable persons of ordinary skill in the art to understand exemplary features and functions of the present disclosure. Such persons would understand, however, that the present disclosure is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any one of the above-described exemplary embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any one of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A skilled person would further appreciate that any one of the various illustrative logical blocks, units, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software unit”), or any combination of these techniques.

To clearly illustrate this interchangeability of hardware, firmware and software, various illustrative components, blocks, units, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure. In accordance with various embodiments, a processor, device, component, circuit, structure, machine, unit, etc. can be configured to perform one or more of the functions described herein. The term “configured to” or “configured for” as used herein with respect to a specified operation or function refers to a processor, device, component, circuit, structure, machine, unit, etc. that is physically constructed, programmed and/or arranged to perform the specified operation or function.

Furthermore, a skilled person would understand that various illustrative logical blocks, units, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, units, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein. If implemented in software, the functions can be stored as one or more instructions or code on a computer-readable medium. Thus, the steps of a method or algorithm disclosed herein can be implemented as software stored on a computer-readable medium.

Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “unit” as used herein, refers to software, firmware, hardware, and any combination of these elements for performing the associated functions described herein. Additionally, for purpose of discussion, the various units are described as discrete units; however, as would be apparent to one of ordinary skill in the art, two or more units may be combined to form a single unit that performs the associated functions according embodiments of the present disclosure.

Additionally, memory or other storage, as well as communication components, may be employed in embodiments of the present disclosure. It will be appreciated that, for clarity purposes, the above description has described embodiments of the present disclosure with reference to different functional units and processors. However, it will be apparent that any suitable distribution of functionality between different functional units, processing logic elements or domains may be used without detracting from the present disclosure. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the implementations described in this disclosure will be readily apparent to those skilled in the art, and the general principles defined herein can be applied to other implementations without departing from the scope of this disclosure. Thus, the disclosure is not intended to be limited to the implementations shown herein, but is to be accorded the widest scope consistent with the novel features and principles disclosed herein, as recited in the claims below.

1. A wireless communication method for use in a wireless network node, the method comprising:
transmitting, to a wireless terminal, a rejection cause associated with a first connectivity request and an indication for at least one access type associated with the rejection cause.

2. The wireless communication method of claim 1, wherein the first connectivity request is a protocol data unit session establishment request or a packet data network connectivity request.

3. The wireless communication method of claim 1, further comprising:
receiving, from a network slice admission control function, a network slice admission control result associated with a rejection for the first connectivity request.

4. The wireless communication method of claim 3, wherein the network slice admission control result indicates at least one of:
a maximum number of wireless terminals associated with a network slice or single network slice selection assistance information has been reached, or
a maximum number of protocol data unit sessions associated with a network slice or single network slice selection assistance information has been reached.

5. The wireless communication method of claim 1, wherein the rejection cause indicates at least one of:
insufficient resources,
a maximum number of wireless terminals associated with a network slice or single network slice selection assistance information has been reached, or
a maximum number of protocol data unit sessions associated with a network slice or single network slice selection assistance information has been reached.

6. The wireless communication method of claim 1, wherein the at least one access type comprises at least one of a 3^{rd} generation partnership project, 3GPP, access type, a non-3GPP access type, or a first access type associated with the first connectivity request.

7. The wireless communication method of claim 1, wherein the at least one access type comprises only a first access type associated with the first connectivity request,
wherein the method further comprises:
receiving, from the wireless terminal, a second connectivity request over a second access type different from the first access type, and
wherein the first connectivity request and the second connectivity request are associated with the same single network slice selection assistance information or the same access point name.

8. The wireless communication method of claim 7, wherein the rejection cause indicates insufficient resources, and
wherein the first connectivity request and the second connectivity request are associated with the same access point name.

9. The wireless communication method of claim 1, wherein the at least one access type comprises only a first access type associated with the first connectivity request,
wherein the method further comprises:
receiving, from the wireless terminal, a second connectivity request over the first access type associated with the first connectivity request after a back-off timer expires, and
wherein the first connectivity request and the second connectivity request are associated with the same single network slice selection assistance information or the same access point name.

10. The wireless communication method of claim 1, wherein the at least one access type comprises a 3GPP access type and a non-3GPP access type,
wherein the method further comprises:
receiving, from the wireless terminal, a second connectivity request over the 3GPP access type or the non-3GPP access type after a back-off timer expires, and
wherein the first connectivity request and the second connectivity request are associated with the same single network slice selection assistance information or the same access point name.

11. The wireless communication method of claim 10, wherein the rejection cause indicates insufficient resources, and
wherein the first connectivity request and the second connectivity request are associated with the same access point name.

12. The wireless communication method of claim 1, further comprising:
transmitting, to the wireless terminal, a back-off timer associated with the first connectivity request.

13. The wireless communication method of claim 1, wherein the wireless network node comprises at least one of a session management function or a combination node of a session management function and a packet data network gateway control plane function.

14. A wireless communication method for use in a wireless terminal, the method comprising:
receiving, from a wireless network node, a rejection cause associated with a first connectivity request and an indication for at least one access type associated with the rejection cause.

15. The wireless communication method of claim 14, wherein the first connectivity request is a protocol data unit session establishment request or a packet data network connectivity request.

16. The wireless communication method of claim 14, wherein the rejection cause indicates at least one of:
insufficient resources,
a maximum number of wireless terminals associated with a network slice or single network slice selection assistance information has been reached, or
a maximum number of protocol data unit sessions associated with a network slice or single network slice selection assistance information has been reached.

17. The wireless communication method of claim 14, wherein the at least one access type comprises at least one of a 3^{rd} generation partnership project, 3GPP, access type, a non-3GPP access type, or a current access type associated with the first connectivity request.

18. The wireless communication method of claim 14, further comprising:
transmitting, to the wireless network node, a second connectivity request associated with the same single network slice selection assistance information or the same access point name as the first connectivity request based on at least one of the rejection cause or the indication.

19. The wireless communication method of claim 14, wherein the at least one access type comprises only a first access type associated with the first connectivity request,
wherein the method further comprises:
transmitting, to the wireless network node, a second connectivity request over a second access type different from the first access type, and
wherein the first connectivity request and the second connectivity request are associated with the same single network slice selection assistance information or the same access point name.

20. The wireless communication method of claim 19, wherein the rejection cause indicates insufficient resources, and
wherein the first connectivity request and the second connectivity request are associated with the same access point name.
